(19) United States
(12) Patent Application Publication
(10) Pub. No.: US 2004/0183229 A1
(43) Pub. Date: Sep. 23, 2004

(54) Process for film insert molding of decorated films

(76) Inventors: Roland Kunzel, Leverkusen (DE); Axel Kaminski, Wermelskirchen (DE); Winfried Kohl, Koln (DE); Klaus Schurmann, Bonen (DE)

Correspondence Address: BAYER MATERIAL SCIENCE LLC, 100 BAYER ROAD, PITTSBURGH, PA, 15205, US

(21) Appl. No.: 10/801,223

(22) Filed: Mar. 16, 2004

(30) Foreign Application Priority Data
Mar. 21, 2003 (DE) 10312610.4

(51) Int. Cl. B29C 45/14

(52) U.S. Cl. 264/279

(57) ABSTRACT

A process of molding a decorated article by injection is disclosed. The process entails the placing against an internal wall of a mold cavity that includes one or more inlet orifices, a decorated film and providing one or more protective elements each element positioned on the film opposite an inlet orifice, and introducing into the mold through the one or more orifices a thermoplastic polymeric molding composition by injection.

### FIELD OF THE INVENTION

The invention relates to molding of decorated articles and more particularly to film insert molding.

### SUMMARY OF THE INVENTION

A process of molding a decorated article by injection is disclosed. The process entails the placing against an internal wall of a mold cavity that includes one or more inlet orifices, a decorated film and providing one or more protective elements each element positioned on the film opposite an inlet orifice, and introducing into the mold through the one or more orifices a thermoplastic polymeric molding composition by injection.

### BACKGROUND OF THE INVENTION

Film insert molding (in-mold decoration) is a widely used surface finishing process. In this process, a decorated film is shaped, trimmed and then positioned in the injection mold and a molten molding composition is then injected in the mold on the back of the film. In the case of films decorated on their backside, while the decoration is indeed protected by the external transparent film, when such films are insert molded the decoration is exposed to elevated temperatures and shear stresses which result in washing out in the area of the gates. In order to avoid washing out, it is known to cover the decorative layer with a protective layer such that the melt does not come directly into contact with the decorative layer. Such a protective layer consists, for example, of polycarbonate (PC), acrylonitrile/butadiene/styrene (ABS), polymethyl methacrylate (PMMA), acrylonitrile/styrene/acrylate (ASA). Said layer is either applied directly during production of a component by coextrusion or is subsequently laminated with the assistance of coupling agents. This process is described, for example, in P. Enewoldsen, H. Braun, Folienhinterspritzen—Dekorieren in der Sprizgieβmaschine, KU Kunststoffe 89 (1999) 9, pages 102-104.

One disadvantage of this process is that protection of the entire surface is not actually necessary since washing out only occurs locally at the gates. More protective material is thus used than is necessary. Moreover, this multilayer structure may overall result in reduced adhesion of the decorative layer to the complete component. One substantial disadvantage, however, is the inadequate three-dimensional forming. Thermoforming is only possible under certain conditions as, in most cases, the coupling agent with which the protective layer is applied onto the decorative layer results in the formation of gas bubbles between the layers.

Furthermore, such multilayer films can only be formed below the softening point. However, the area which can be formed by the high pressure forming process used for this purpose is limited.

It is furthermore known, in order to improve heat dissipation, to chill the decorated film prior to insert molding with a cooling spray. In this case, the film is at least so strongly chilled that the heat of the melt is insufficient to cause the printing ink to melt and be displaced. The disadvantage here, however, is that relatively thin films of a thickness of approx. 100 μm cannot be sufficiently chilled as they absorb heat again too rapidly. Alternatively, the injection mold may be adapted in such a manner that the shear rate and throughput, e.g. volume throughput, per gate are lower. However, this entails a larger number of gates which in turn results in an increased number of weld lines and, consequently, reduced strength at the weld lines.

A process is furthermore known in which the decorative layer is partially overprinted in the area of the gates With a clear lacquer, for example a two-component polyurethane lacquer. However, said process cannot be used in the vicinity of formed portions as, once cured, the lacquer can no longer be formed.

### BRIEF DESCRIPTION OF THE DRAWING

FIG. 1 is a schematic representation of a mold, film used in film insert molding and a protective element according to the inventive process.

### DETAILED DESCRIPTION OF THE INVENTION

The object of the invention is accordingly to provide a process for film insert molding of decorated films, in which washing out of the decorated film is avoided in the area of the inlet orifices for the melt into the mold cavity of the injection mold.

The present invention accordingly provides a process for film insert molding of decorated films with a thermoplastic polymer, wherein the film lies with its entire surface against the internal wall of the mold cavity, which process is characterised in that, prior to film insert molding, the decorated film is provided with one or more protective elements, each positioned in the area facing an inlet orifice for the injection of thermoplastic polymer into the mold cavity.

The protective element is applied onto the decorative layer of the decorated film opposite one or more inlet orifices, such that, on injection into the mold cavity, the polymer melt does not come into contact with the decoration in the area of the gate. On the one hand, the protective element provides thermal insulation. During film insert molding, it prevents the heat of the thermoplastic polymer from melting the printing ink and causing it to flow with the melt. On the other hand, the protective element also provides mechanical protection by preventing the melt from coming into direct contact with the decorated film. In this manner, the protective element protects the printing ink from the elevated shear stresses in the area of the gates during film insert molding.

The area of the protective element depends upon the area of washing out. The size of the inlet orifice, through which the thermoplastic polymer passes into the injection mold, substantially determines the area of washing out. The area of the protective element is preferably at least twice, preferably at least ten times, the cross-section of the respective opposing inlet orifice.

The protective element is preferably a mesh, woven, braided or nonwoven fabric of metal, polymer and/or natural material and/or a foil/film of metal and/or polymer. Metals which may, for example, be used are aluminium, copper, alloys or steel. Polymers which may be used are elastomers or thermoplastics. The polymers may optionally also be provided with reinforcing materials and/or fillers, for example glass fibres. The protective element may be, for example, any of the following polymers: polycarbonate (PC), acrylonitrile/butadiene/styrene (ABS), styrene/acrylo-nitrile (SAN), polybutylene terephthalate (PBT), polyamide (PA), thermoplastic polyurethane (TPU), polyethylene terephthalate (PET), polystyrene (PS), polyoxymethylene (POM), polyolefins, in particular polypropylene (PP), polyester, polymethyl methacrylate (PMMA), thermoplastic polyvinyl chloride (PVC) or mixtures of thermoplastic polymers.

Natural materials which may be selected include cotton, cellulose, hemp, flax or cork. A combination of the stated sheet materials and/or materials is also possible.

The thickness of the protective element depends upon the quantity of polymer injected through the inlet orifice. The protective element preferably has a thickness of at least 50 μm.

The protective element is preferably applied onto the decorated film by means of an adhesive bond. Adhesives which may, for example, be used for this purpose are aqueous polyurethane dispersions, aqueous acrylate/copolymer dispersions and polyurethanes dissolved in organic solvents. Alternatively, the protective element may also be applied by heating the film and then compressing the protective element with the film. The protective element may moreover be applied onto the decorated film by welding.

The process according to the invention makes it possible to achieve direct gating without washing out. Gating via tabs or pins is thus unnecessary. Direct gating moreover has the advantage that it is possible to make use of the cascade method, i.e. time-delayed actuation of the inlet orifices. Furthermore, no structural changes to the injection mold are required, such as for example the introduction of additional gates to reduce the volume throughput per gate. The protective element may furthermore be adapted to the local shape of the decorated film. Moreover, less material is consumed and processing is less complex in comparison with conventional processes as the quantity of material required for protection is reduced to a minimum and, instead of a protective layer covering the entire area, only a local protective element need be applied.

The decorated films are insert molded by the process according to the invention using thermoplastic polymers which are unfilled or provided with reinforcing materials and/or fillers, such as polymers comprising polycarbonate, acrylonitrile/butadiene/styrene (ABS), styrene/acrylonitrile (SAN), polybutylene terephthalate (PBT), polyamide (PA), thermoplastic polyurethane (TPU), polyethylene terephthalate (PET), polystyrene (PS), polyoxymethylene (POM), polyolefins, for example polyethylene (PE), polypropylene (PP), polyester, polymethyl methacrylate (PMMA), elastomer-modified blends, thermoplastic PVC or mixtures of thermoplastic polymers.

The thickness of the insert molded thermoplastic polymer varies greatly as a function of the application. The thickness of the polymer layer is preferably 1 to 6 mm, but may range from a few tenths of a millimeter to greater than 10 mm (thermoplastic foam casting).

Suitable materials for the decorated film include polycarbonate, ABS, cellulose ester, polyethylene (PE), polypropylene (PP), polyethylene terephthalate (PET), polybutylene terephthalate (PBT), polymethyl methacrylate (PM MA), PVC, polyester, polysulfones, polyethersulfones, polyetherether ketones (PEEK), polyarylethersulfones, polyurethane (PU) and polyamide (PA). Functional multilayer films, films made from polymer mixtures or blends or films provided with reinforcing materials and/or fillers may furthermore be used.

The films may be decorated by such means as screen printing. Further methods for decorating the film include lacquer coating, laminating, pad printing, offset printing, thermal transfer printing, relief printing (including flexographic printing), planographic printing, gravure printing, inkjet printing, photography, thermography, magnetography, ionography or electrography.

The printing inks conventional for the particular method, for example screen printing inks, are used for decorating the film.

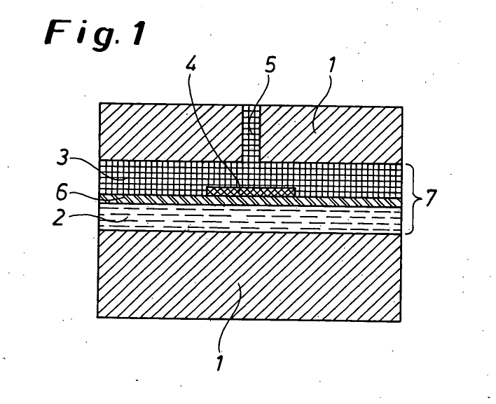

The invention is illustrated in greater detail in the attached FIG. 1.

FIG. 1 is a schematic diagram showing film 2 with decorative layer 6 positioned in the mold cavity 7 of an injection mold 1, the film is positioned with its entire surface against the internal wall of the mold cavity 7. The decorative layer 6 is provided with a protective element 4. The thermoplastic polymer 3, enters the mold cavity 7 via the inlet orifice 5 of the mold 1.

### EXAMPLE

Film insert molding of a decorative film for an engine cover is described. A polycarbonate film which has been screen printed on its backside with a solution of synthetic resins in organic solvents (Noriphan® HTR from Proell KG, Germany). Once it had been printed, the film was shaped by thermoforming and then trimmed. Protective elements of polycarbonate with an area of 24×75 mm² were then applied onto the decorated film in the area of the gates. To this end, the protective elements were provided with a coupling agent prepared from polyurethane dissolved in organic solvents (Mecotherm® L110 from Kissel & Wolf, Germany). Once provided with protective elements, the film was positioned in the mold cavity of the injection mold and polyamide 6 was injected on the back of the film. The size of the gate was 50×3.6 mm². The weight of thermoplastic polymer per gate was 80 g.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process of molding a decorated article by injection comprising placing against an internal wall of a mold cavity that includes one or more inlet orifices, a decorated film and providing one or more protective elements each element positioned on said film opposite an inlet orifice, and introducing into the mold through the one or more inlet orifices a thermoplastic polymeric molding composition by injection.

2. The process according to claim 1 wherein the protective element has an area that is at least twice the distance between the element and the opposite inlet orifice.

3. The process according to claim 1 wherein the protective element is a mesh, woven, braided or nonwoven fabric of metal or polymer.

4. The process according to claim 1 wherein the protective element is fastened to the decorated film by an adhesive.

5. The process according to claim 1 wherein the protective element is fastened to the decorated film by heat and pressure.

6. The process according to claim 1 wherein the protective element is fastened to the decorated film by welding.
